(19) United States
(12) Patent Application Publication
(10) Pub. No.: US 2026/0362153 A1
(43) Pub. Date: Nov. 12, 2026

(54) RADIO ZONE DESIGN SUPPORT APPARATUS, RADIO ZONE DESIGN SUPPORT METHOD AND PROGRAM

(71) Applicant: NTT, Inc., Tokyo (JP)

(72) Inventors: Toshiro NAKAHIRA, Tokyo (JP); Daisuke MURAYAMA, Tokyo (JP); So TAKATANI, Tokyo (JP); Takatsune MORIYAMA, Tokyo (JP)

(21) Appl. No.: 19/120,891

(22) PCT Filed: Nov. 9, 2022
(86) PCT No.: PCT/JP2022/041708

§ 371 Date: Apr. 14, 2025

(51) Int. Cl. H04W 16/18; H04W 48/16; H04W 48/20; H04W 72/044

(52) U.S. Cl. CPC H04W 16/18; H04W 48/16; H04W 48/20; H04W 72/0473

(57) ABSTRACT

A radio zone design support apparatus includes: a calculation unit configured to calculate, for one or more points, received power from each one of a plurality of candidates for an arrangement position of a base station; and a determination unit configured to determine the arrangement position of the base station from among the candidates in which received power values at all the points are equal to or less than a threshold, thereby allowing for efficient station placement design while reducing radio wave interference.

### TECHNICAL FIELD

The present invention relates to a radio zone design support apparatus, a radio zone design support method, and a program.

### BACKGROUND ART

In order to establish a coverage area of a wireless communication system, station placement design for determining base station arrangement (installation locations and antenna directions) is performed. In the station placement design, the base station arrangement is selected and then a service area simulation is performed in some cases, and methods such as estimation by an experimental formula (Non-Patent Literature 1) and ray tracing (Non-Patent Literature 2) are used.

### CITATION LIST

### Non-Patent Literature

Non-Patent Literature 1: “Station Placement Design in Mobile Communication”, NTT DoCoMo Technical Journal vol.2 no.4, [online], the Internet <https://www.nttdocomo.co.jp/binary/pdf/corporate/technology/rd/technical_journal/bn/vol2_4/vol2_4_035jp.pdf>
Non-Patent Literature 2: “Ray Tracing Using Genetic Algorithm for Radio Wave Propagation Estimation”, NTT DoCoMo Technical Journal vol.15 no.3, [online], the Internet <https://www.nttdocomo.co.jp/binary/pdf/corporate/technology/rd/technical_journal/bn/vol15_3/vol15_3_020jp.pdf>
Non-Patent Literature 3: “Local 5G License Application Support Manual”, P14-15, P83-106, [online], the Internet <https://5gmf.jp/wp/wp-content/uploads/2020/12/local-5g-manual2.pdf>

### SUMMARY OF INVENTION

### Technical Problem

Private wireless systems include a wireless system such as local 5G that is permitted to be used only in a case where a condition for suppressing radio wave interference to a location other than a use location, to a certain standard or less, is satisfied (e.g., Non-Patent Literature 3). Thus, when station placement design for the wireless system is performed for a use location, it is necessary to establish a service area for the use location while suppressing radio wave interference to a location other than the use location, at or below a certain standard. However, in a conventional technology in which after selecting the base station arrangement, whether a required quality is satisfied for the service area is evaluated, it is difficult to perform the station placement design in consideration of such a condition.

Thus, when attempting to secure a certain degree of separation distance in order to suppress the radio wave interference to a location other than a use location at or below a certain standard, the arrangement of the base stations is greatly restricted, and this results in a problem such as inefficient station placement design or failing to secure a sufficient service area.

The present invention has been made in view of the above point, and an object of the present invention is to allow for efficient station placement design while reducing radio wave interference.

### Solution to Problem

Thus, in order to solve the above problem, a radio zone design support apparatus includes: a calculation unit configured to calculate, for one or more points, received power from each one of a plurality of candidates for an arrangement position of a base station; and a determination unit configured to determine the arrangement position of the base station from among the candidates in which received power values at all the points are equal to or less than a threshold

### Effect of Invention

It is possible to allow for efficient station placement design while reducing radio wave interference.

### BRIEF DESCRIPTION OF DRAWINGS

FIG. 1 is a diagram illustrating a hardware configuration example of a radio zone design support apparatus 10 according to an embodiment of the present invention.

FIG. 2 is a diagram illustrating a functional configuration example of the radio zone design support apparatus 10 according to the embodiment of the present invention.

FIG. 3 is a flowchart for describing an example of a processing procedure executed by the radio zone design support apparatus 10.

FIG. 4 is a diagram for describing target area information.

### DESCRIPTION OF EMBODIMENTS

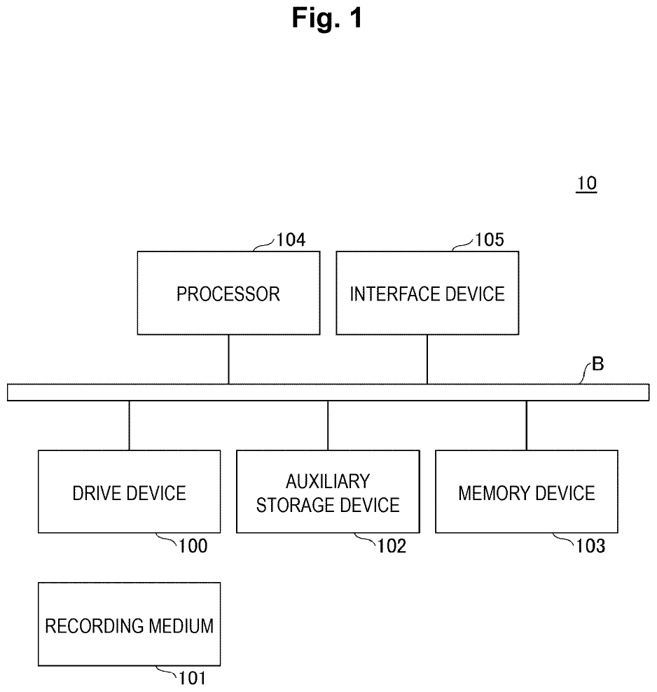

One or embodiments of the present invention will be described below with reference to the drawings. FIG. 1 is a diagram illustrating a hardware configuration example of a radio zone design support apparatus 10 according to the embodiment of the present invention. The radio zone design support apparatus 10 in FIG. 1 includes a drive device 100, an auxiliary storage device 102, a memory device 103, a processor 104, an interface device 105, and the like, which are connected to one another by a bus B.

A program for implementing processing in the radio zone design support apparatus 10 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101, and may be downloaded from another computer via a network. The auxiliary storage device 102 stores the installed program and also stores required files, data, and the like.

In a case where a command to start the program is issued, the memory device 103 reads the program from the auxiliary storage device 102 and stores the program. The processor 104 is a CPU or a graphics processing unit (GPU), or includes a CPU and GPU. The processor 104 executes a function relating to the radio zone design support apparatus 10 according to the program stored in the memory device 103. The interface device 105 is used as an interface for a connection to the network.

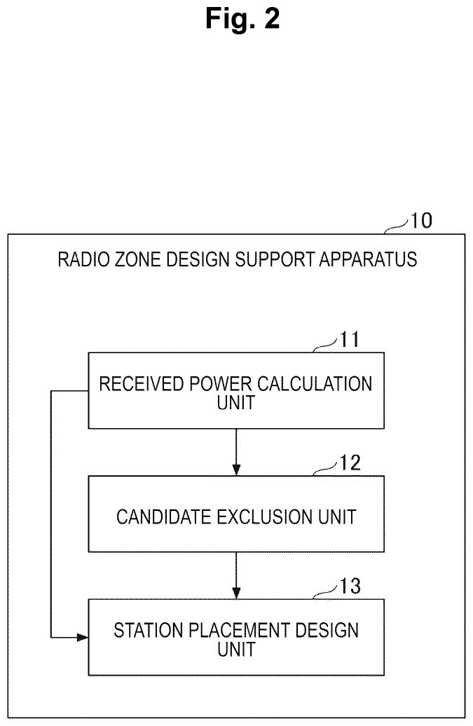

FIG. 2 is a diagram illustrating a functional configuration example of the radio zone design support apparatus 10 according to the embodiment of the present invention. In FIG. 2, the radio zone design support apparatus 10 includes a received power calculation unit 11, a candidate exclusion unit 12, and a station placement design unit 13. Each of these units is implemented by processing in which one or more programs installed in the radio zone design support apparatus 10 cause the processor 104 to execute.

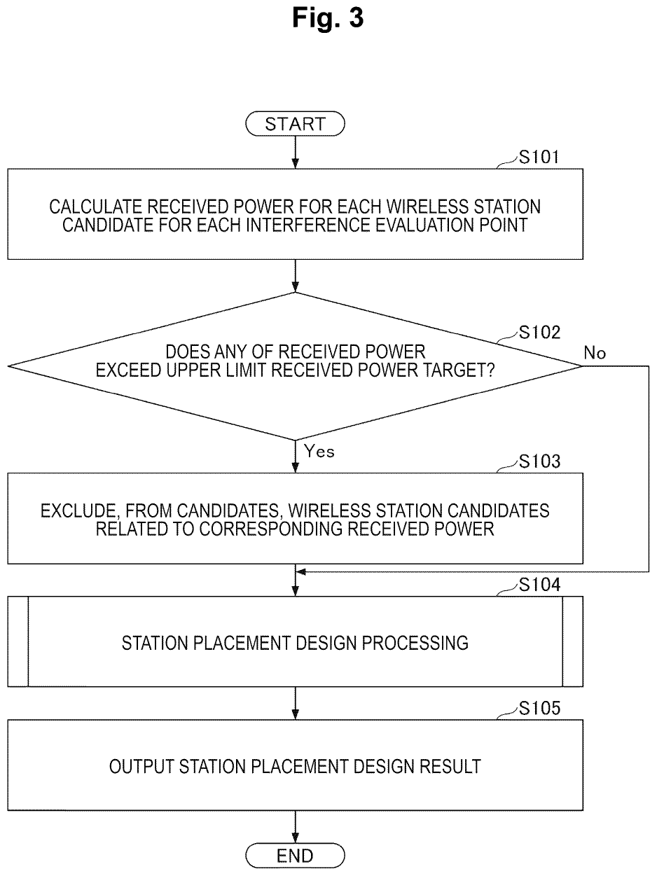

Hereinafter, a processing procedure executed by the radio zone design support apparatus 10 will be described. FIG. 3 is a flowchart for illustrating an example of a processing procedure executed by the radio zone design support apparatus 10.

In step S101, for example, the received power calculation unit 11 calculates received power from a plurality of wireless station candidates for one or more points (hereinafter referred to as “interference evaluation points”) set outside the site of a geographical range (hereinafter referred to as a “target area”) in which a wireless system such as a private wireless system is scheduled to be used.

The wireless station candidates refer to candidates for arrangement positions of one or more base stations constituting a target wireless system. The interference evaluation points are points included in an area where it is required to suppress radio wave interference by the target wireless system to be at or below a certain standard, and are set in advance. Information indicating the plurality of wireless station candidates and the one or more interference evaluation points is included in information regarding the target area (hereinafter referred to as “target area information”) and is stored in the auxiliary storage device 102 or the like in advance. The target area information also includes information indicating the environment of the target area, such as the size and shape of the target area, and a range (position) and material of a structure, or the like.

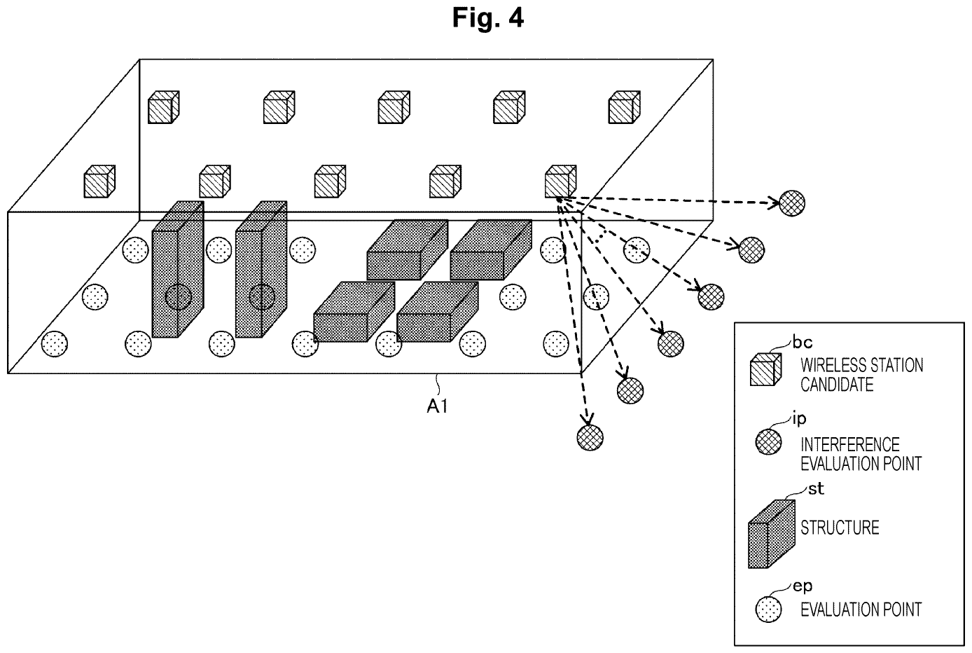

FIG. 4 is a diagram for describing the target area information. FIG. 4 illustrates an example in which a target area A1 has a rectangular shape for convenience, and 10 wireless station candidates bc are set in a space of the target area A1. In FIG. 4, since a situation is assumed in which the target area is the inside of a certain event venue, the shape of the venue is expressed in three dimensions. FIG. 4 illustrates an example in which six interference evaluation points ip are set outside the site of the target area. In addition, arrangement positions and shapes of six structures st are clarified. Furthermore, 15 evaluation points are set. Note that position information of the wireless station candidates bc, the interference evaluation points ip, the structures st, and evaluation points ep may be three-dimensional coordinate information or two-dimensional coordinate information.

In FIG. 4, one wireless station candidate bc and the six interference evaluation points ip are connected by dashed arrows. This indicates that received power at the six interference evaluation points ip is calculated for radio waves from the wireless station candidate bc. Such a calculation of the received power is performed for all 10 wireless station candidates bc. Therefore, 10 received power values are calculated for each interference evaluation point ip. The received power can be calculated using a known technology. For example, the received power may be calculated in consideration of, for example, whether the structures st exist between the interference evaluation points ip and the wireless station candidates bc.

The positions of the interference evaluation points ip may be selected from, for example, a range in which radio wave interference may occur, or a range in which it is required to reduce radio wave interference within a certain standard.

Note that the evaluation points ep refer to points set in advance as locations where it is required that wireless communication can be performed in the target area. For example, locations where it is assumed that terminals would be used are set as the evaluation points.

Subsequently, the candidate exclusion unit 12 determines whether any of the calculated received power values exceeds an upper limit received power target (S102). The upper limit received power target is a threshold set in advance from the viewpoint of suppressing radio wave interference to be at or below a certain standard. The upper limit received power target may be the same value for all the interference evaluation points, or may be different values for some or all the interference evaluation points.

If all the received power values are equal to or less than the upper limit received power target (No in S102), the processing proceeds to step S104. If any of the received power values exceed the upper limit received power target (Yes in S102), step S103 is executed, and the processing proceeds to step S104.

In step S103, the candidate exclusion unit 12 excludes (invalidates) wireless station candidates related to the received power value that exceeds the upper limit received power target. That is, the wireless station candidates are excluded from the candidates for arrangement positions of base stations. The wireless station candidates that have not been excluded in step S103 are referred to as “valid wireless station candidates”.

In step S104, the station placement design unit 13 executes station placement design processing. The station placement design processing is processing for determining the number of base stations to be arranged and the arrangement positions of the base stations. At this time, the arrangement positions of the base stations are selected from among the valid wireless station candidates (that is, the wireless station candidates in which all the received power values are equal to or less than the upper limit received power target). It is therefore possible to allow for station placement design in which radio wave interference at the interference evaluation points ip can be reduced. The station placement design refers to determining the arrangement (installation location and antenna orientation) of the base stations in order to establish a coverage area of the wireless system.

The station placement design processing can be performed using a known technology. For example, the station placement design unit 13 calculates the received power values from all the valid wireless station candidates for all the evaluation points. The evaluation points may be selected by a predetermined method from a range to be covered for wireless communication in the target area.

Subsequently, the station placement design unit 13 selects a predetermined number of wireless station candidates from among the valid wireless station candidates. Specific examples of the method of selection include the following two methods, (A) and (B).

(A) By a greedy algorithm, wireless station candidates that satisfy required communication qualities at more evaluation points are selected until a predetermined number is reached. The required communication quality at an evaluation point refers to required received power set for each evaluation point. Therefore, a wireless station candidate that satisfies a required communication quality at a certain evaluation point refers to a wireless station candidate in which the received power at the evaluation point is equal to or higher than the required communication quality.

(B) Evaluation points are divided into a predetermined number of clusters, and a wireless station candidate that satisfies the required communication qualities at more evaluation points is selected for each cluster. A non-hierarchical or hierarchical algorithm can be used for cluster division.

Subsequently, the station placement design unit 13 determines whether there is a possibility that there will be a terminal that cannot be accommodated in a case where base stations are arranged at the wireless station candidates selected by the method (A) or (B). It is possible to determine whether there is a possibility that there will be a terminal that cannot be accommodated by determining whether there is an evaluation point ep at which the received power is less than the threshold. Furthermore, whether there is a possibility that there will be a terminal that cannot be accommodated may be determined in consideration of a restriction on the number of terminals that can be accommodated in the base stations at the selected wireless station candidates.

If it is determined that there is no possibility that there will be a terminal that cannot be accommodated, the station placement design unit 13 determines the selected wireless station candidates as arrangement positions of the base stations. If it is determined that there is a possibility that there will be a terminal that cannot be accommodated, the station placement design unit 13 changes a station placement design condition (e.g., the number of base stations to be arranged), and executes again the processing from selection of wireless station candidates from among valid wireless station candidates.

Subsequently, the station placement design unit 13 outputs, as a station placement design result, information indicating the wireless station candidates determined as the arrangement positions of the base stations (S105).

The above description shows an example in which the interference evaluation points ip are points different from the evaluation points ep (points outside the range of target area A1), but it is also possible to set any of the evaluation points ep as the interference evaluation points ip. In this case, both the “required communication quality” and the “upper limit received power target” may be set for the evaluation points ep, and one or both of them may be set for each evaluation point ep. The evaluation points ep for which the “upper limit received power target” has been set may be treated as the interference evaluation points ip.

In the above description, only the positions of the wireless station candidates are taken into consideration and the states of the base stations are not taken into consideration, but it is also possible to set a plurality of wireless station candidates for the same position in consideration of differences in state between the base stations. For example, a plurality of wireless station candidates that differ in base station installation orientation may be set for the same position in consideration of directivity of the base stations. In addition, it may be considered in some cases that an antenna to be used can be selected from a plurality of antennas for one base station. In this case, a plurality of wireless station candidates that differ in antenna type may be set for the same position.

Furthermore, the above description is based on the assumption that a single wireless communication system is used, but it is also possible to utilize a combination of a plurality of different wireless communication systems between base stations or between a base station and a relay station. In that case, since the received power does not allow for a fair evaluation across wireless communication systems, the communication quality may be evaluated after conversion into a comparable index such as a wireless transmission rate expectation value.

As described above, according to the present embodiment, it is possible to efficiently perform the station placement design that satisfies the required quality for the target area while suppressing the radio wave interference to areas other than the target area to a certain standard or less. That is, it is possible to allow for efficient station placement design while reducing radio wave interference.

In the present embodiment, the received power calculation unit 11 is an example of a calculation unit. The station placement design unit 13 is an example of a determination unit.

Although the embodiment of the present invention has been described in detail above, the present invention is not limited to such a specific embodiment, and various modifications and changes can be made within the scope of the gist of the present invention described in the claims.

### REFERENCE SIGNS LIST

10 Radio zone design support apparatus
11 Received power calculation unit
12 Candidate exclusion unit
13 Station placement design unit
100 Drive device
101 Recording medium
102 Auxiliary storage device
103 Memory device
104 Processor
105 Interface device
B Bus

1. A radio zone design support apparatus comprising:
circuitry configured to:
calculate, for one or more locations, received power from each of a plurality of candidates for a position at which a base station is to be arranged; and
determine the position at which the base station is to be arranged, from among one or more of the plurality of candidates, wherein for the one or more candidates, received power at all locations is equal to or less than a threshold.

2. The radio zone design support apparatus according to claim 1, wherein the one or more locations are included in an area in which a reduction in radio wave interference of wireless communication using the base station is required.

3. The radio zone design support apparatus according to claim 1, wherein the plurality of candidates includes, as other candidates, base stations that are the same in position but different in state.

4. A radio zone design support method executed by a computer, comprising:
calculating, for one or more locations, received power from each of a plurality of candidates for a position at which a base station is to be arranged; and
determining the position at which the base station is to be arranged, from among one or more of the plurality of candidates, wherein for the one or more candidates, received power values at all locations is equal to or less than a threshold.

5. A non-transitory computer readable storage medium storing a program configured for causing a computer to execute a method, the method comprising:
calculating, for one or more locations, received power from each of a plurality of candidates for a position at which a base station is to be arranged; and
determining the position at which the base station is to be arranged, from among one or more of the plurality of candidates, wherein for the one or more candidate, received power values at all locations is equal to or less than a threshold.
